(19) United States
(12) Patent Application Publication
(10) Pub. No.: US 2003/0038486 A1
(43) Pub. Date: Feb. 27, 2003

(54) Vehicle door handle assembly

(76) Inventors: Morihito Nomura, Chiryu-shi (JP); Yasuo Imatomi, Toyota-shi (JP); Kouichi Nagata, Obu-shi (JP); Akira Kondo, Nagoya-shi (JP); Atsushi Kamiya, Kariya-shi (JP); Katsuaki Maruyama, Toyota-shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/207,776

(22) Filed: Jul. 31, 2002

(30) Foreign Application Priority Data
Jul. 31, 2001 (JP) 2001-232790

(51) Int. Cl. E05B 3/00

(52) U.S. Cl. 292/336.3

(57) ABSTRACT

A handle lever is rotatable and movable in an axial direction relative to a frame and when the handle lever is rotatably moved from a predetermined position in a rotation direction with a predetermined amount against a urging force of a rotative urging spring and also moved from a predetermined position in the axial direction with a predetermined amount against a urging force of an axial urging spring, an engaging hook of the handle lever is engaged with an engaging portion of the frame in the rotation direction and the axial direction for holding the handle lever in a tentative holding position.

This application is based on and claims priority under 35 U.S.C. §119 with respect to Japanese Application No. 2001-232790 filed on Jul. 31, 2001, the entire content of which is incorporated herein by reference.

### FIELD OF THE INVENTION

This invention generally relates to a vehicle door handle assembly. More particularly, the present invention pertains to a vehicle door handle assembly which includes a grip type outside door handle.

### BACKGROUND OF THE INVENTION

A Japanese Patent Laid-Open Publication No. H08-35360 discloses a known vehicle door handle assembly of this kind. This known assembly includes a frame secured to an inside of an outer panel for a vehicle door and a handle lever rotatably assembled to the frame by a shaft portion and rotatably urged to a predetermined position in a rotation direction by a rotative urging spring. The vehicle door handle assembly further includes a grip type outer handle installed from an outside of the outer panel and rotatably operating the handle lever. At one end of the grip type outer handle, an engaging portion is provided for being engaged with a supporting portion in an inclinable manner provided at the frame by being inserted through an opening for insertion provided at the outer panel. At the other end of the grip type outer handle, an inserting projection having an engaging concave portion is provided for being engaged with an input portion of the handle lever by being inserted through each opening for insertion provided at the outer panel and the frame.

According to the vehicle door handle assembly disclosed in the above publication, the handle lever is assembled to the supporting portion provided at the frame by means of a supporting shaft so as to be rotatable and movable in an axial direction on the supporting shaft. In addition, a sliding guide lever rotatably assembled on the supporting shaft and rotatably urged to a predetermined position in the rotation direction by a spring (rotative urging spring) is engaged with the handle lever so as to be rotated as a unit. Then, the sliding guide lever is engaged with a stopper projection provided at the frame. The handle lever is urged in the axial direction by a second spring (axial urging spring) assembled on the supporting shaft and in contact with a stopper surface of the sliding guide lever for holding the handle lever in a tentative holding position. Under the condition that the handle lever is maintained at the tentative holding position, the handle lever is movable in the axial direction by overcoming the urging force of the second spring in the axial direction. By using this movement characteristic of the handle lever, the grip type outer handle can be installed in the frame by being pushed from the outside of the outer panel through one-touch operation.

According to the vehicle door handle assembly disclosed in the above publication, when the outer handle is installed in the frame by being pushed from the outside of the outer panel through one-touch operation, the handle lever is required to be moved in the axial direction against the urging force in the axial direction of the second spring. Thus, the assembly condition of the outer handle is not well.

### SUMMARY OF THE INVENTION

It is an object of the present invention to improve an assembly condition of an outer handle toward a frame.

According to an aspect of the present invention, the vehicle door handle assembly includes a frame secured to an inside of an outer panel for a vehicle door, and a handle lever rotatably assembled to the frame by a shaft portion and rotatably urged to a predetermined position in a rotation direction by a rotative urging spring. The vehicle door handle assembly further includes a grip type outer handle installed from an outside of the outer panel and rotatably operating the handle lever. The grip type outer handle includes an engaging portion at one end being inserted through an opening for insertion provided at the outer panel and being engaged with a supporting portion in an inclinable manner provided at the frame, and an inserting projection having an engaging concave portion at the other end being inserted through each opening for insertion provided at the outer panel and the frame and being engaged with an input portion of the handle lever, and an engaging hook formed at the handle lever which is movable in an axial direction of the shaft portion relative to the frame. An engaging hook is formed at the handle lever which is movable in an axial direction of the shaft portion relative to the frame. An engaging portion is formed at the frame for being engaged and disengaged with the engaging hook. An axial urging spring is provided between the handle lever and the frame for urging the handle lever to a predetermined position in the axial direction in which the engaging hook is disengaged from the engaging portion in the axial direction. When the handle lever is rotatably moved from the predetermined position in the rotation direction with a predetermined amount against a urging force of the rotative urging spring and also axially moved from the predetermined position in the axial direction with a predetermined amount against a urging force of the axial urging spring, the engaging hook of the handle lever is engaged with the engaging portion of the frame in the rotation direction and the axial direction for holding the handle lever in a tentative holding position.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements and wherein:

FIG. 1 is a side view of a vehicle door handle assembly viewed from an inside (vehicle compartment side) according to an embodiment of the present invention;

FIG. 2 is a side view of the vehicle door handle assembly of FIG. 1 viewed from an outside;

FIG. 3 is a cross-sectional view taken along a line 3-3 of FIG. 1;

FIG. 4 is a perspective view of the vehicle door handle assembly under the condition that a handle lever is tentatively maintained in engagement with a frame of FIGS. 1-3;

FIG. 5 is an enlarged side view of the vehicle door handle assembly showing a relationship between the frame and the handle lever of FIG. 4;

FIG. 6 is a perspective view of the handle lever of FIGS. 4,5.

### DETAILED DESCRIPTION OF THE INVENTION

An embodiment of the present invention will be explained referring to drawings.

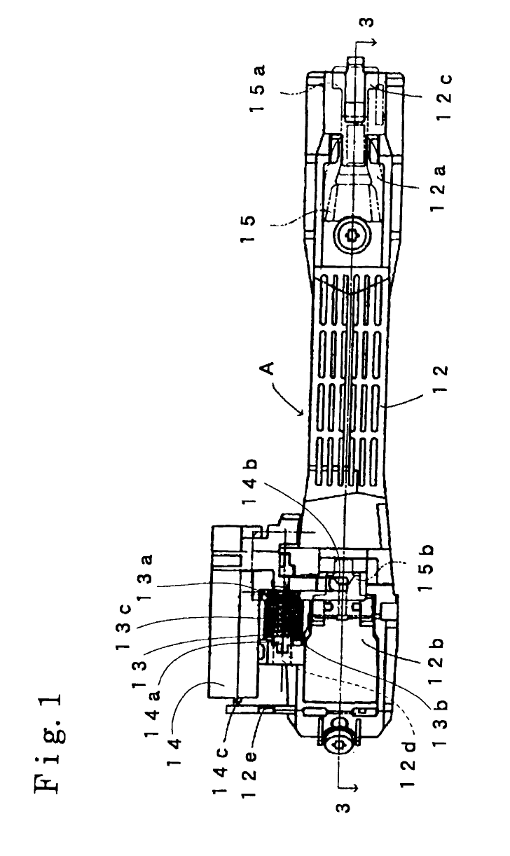

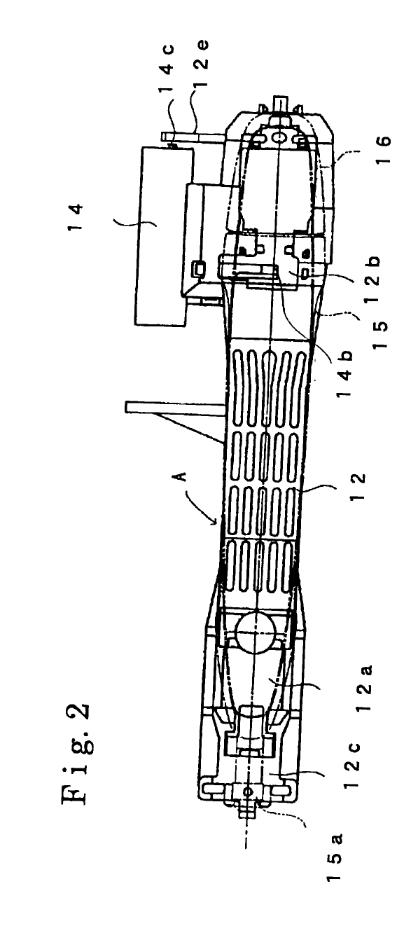

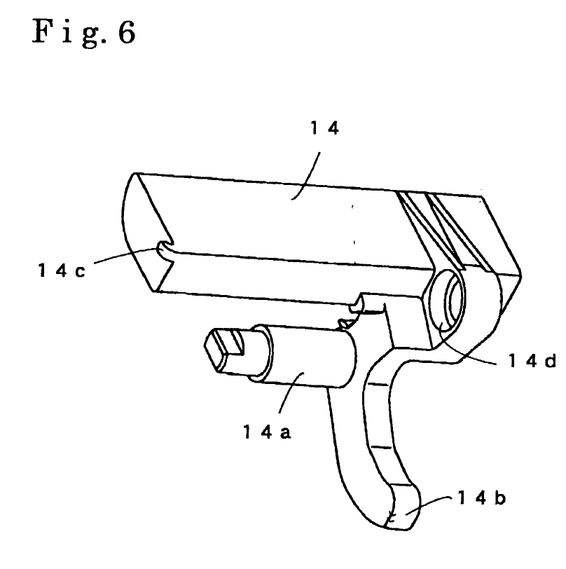

A vehicle door handle assembly A according to the present invention shown in FIGS. 1-6 includes a frame 12 secured to an inside of an outer panel 11 for a vehicle door, a handle lever 14 rotatably assembled to the frame 12 and rotatably urged to a predetermined position in a rotation direction shown in FIGS. 1,2 by a spring coil 13, and a grip type outer handle 15 installed from an outside of the outer panel 11.

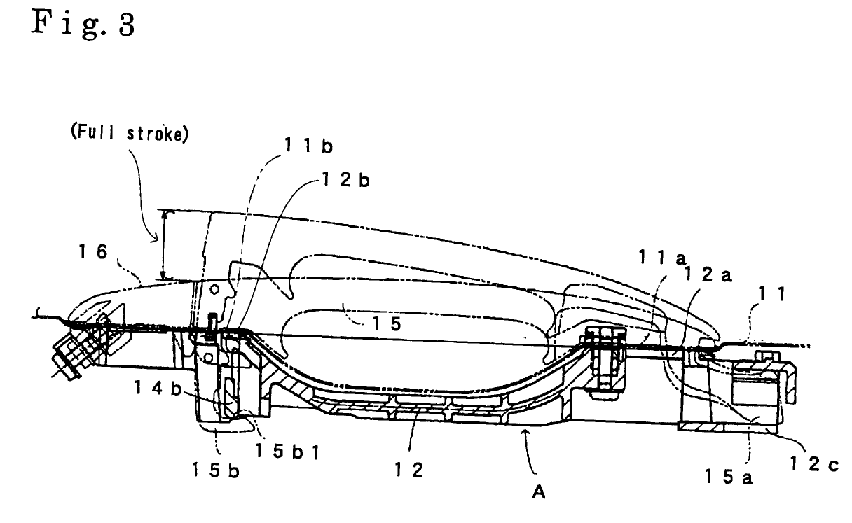

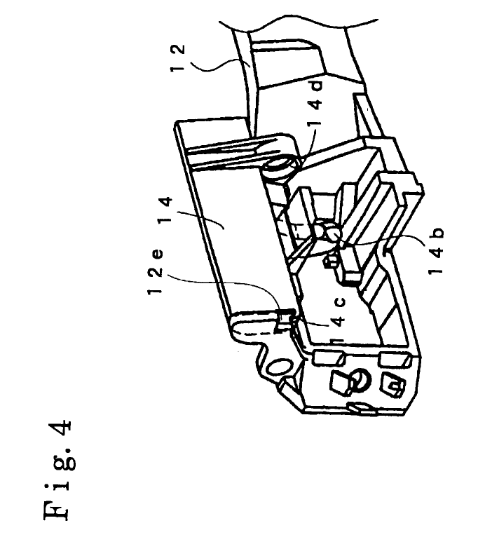

The frame 12 includes an opening for insertion 12a through which an engaging portion 15a provided at one end of the outer handle 15 is inserted, and an opening for insertion 12b through which an inserting projection 15b provided at the other end of the outer handle 15 is inserted. The engaging portion 15a of the outer handle 15 is supported in an inclinable manner by a supporting portion 12c provided close to the opening for insertion 12a. In addition, the frame 12 includes a supporting hole 12d for supporting a shaft portion 14a of the handle lever 14 to be rotatable and movable in an axial direction as shown in FIG. 1. Further, the frame 12 includes an engaging portion 12e as a unit for holding the handle lever 14 in a tentative holding position as shown in FIG. 4. At the outer panel 11, openings for insertion 11a, 11b (shown in FIG. 3) are formed corresponding to the openings for insertion 12a, 12b.

The coil spring 13 has the feature as a rotative urging spring for urging the handle lever 14 in a clockwise direction as viewed from the right side of FIG. 1. The coil spring 13 also has the feature as an axial urging spring for urging the handle lever 14 rightward (axial direction) of FIG. 1. Under the condition that the coil spring 13 is assembled in a set position between the frame 12 and the handle lever 14 (condition in FIG. 1), a right end 13a of FIG. 1 is engaged with the handle lever 14. In addition, a left end 13b of FIG. 1 is engaged with the frame 12, and a cylindrical portion 13c is assembled to the shaft portion 14a of the handle lever 14 with a predetermined gap therebetween.

The handle lever 14 is assembled to the frame 12 at both ends so as to be rotatable and movable in the axial direction. As shown in FIGS. 1, 5, 6, the shaft portion 14a is provided at a central portion of the handle lever 14 for holding the cylindrical portion 13c of the coil spring 13. Further, the handle lever 14 includes an input portion 14b being engaged with an engaging concave portion 15b1 formed at the inserting projection 15b of the outer handle 15, an engaging hook 14c, which is integrally formed with the handle lever 14, projecting in the axial direction and the rotation direction, and an installation hole 14d for installing a clip (not shown). The handle lever 14 may be also called as a bell crank.

The outer handle 15 is provided with the engaging portion 15a at one end for being engaged with the supporting portion 12c of the frame 12 in the inclinable manner. The outer handle 15 is also provided with the inserting projection 15b having the engaging concave portion 15b1 at the other end. The engaging concave portion 15b1 formed at the inserting projection 15b is engaged with the input portion 14b of the handle lever 14. By a cap 16 to be assembled to the frame 12 after the outer handle 15 is installed in the frame 12, the movement of the outer handle 15 along the outer panel 11 is restricted.

When the outer handle 15 is moved with a full-stroke in an outward direction of the vehicle as shown in FIG. 3 under the condition that the outer handle 15 is assembled in a manner as shown by imaginary lines in FIGS. 1-3, the handle lever 14 is rotatably moved against the urging force of the coil spring 13. In case that the handle lever 14 is rotatably moved, a handle lever rod (not shown) connected to the installation hole 14d of the handle lever 14 via the clip is moved for releasing a lock of a door lock device (not shown).

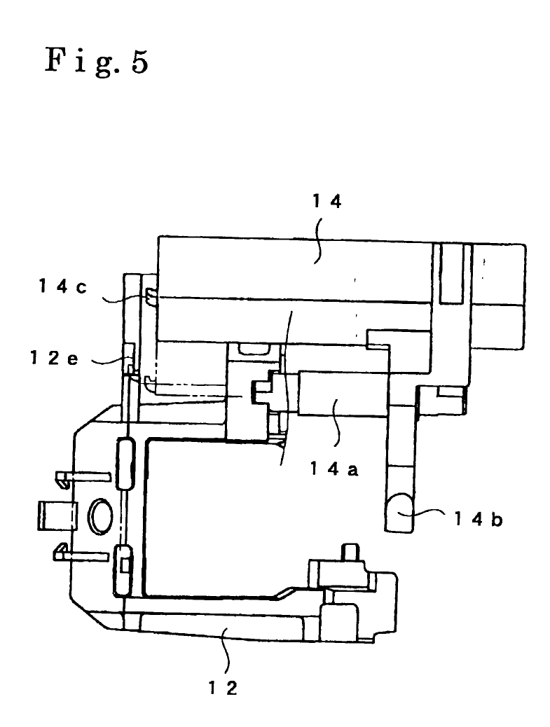

According to the embodiment of the present intention configured in an aforementioned manner, when the handle levee 14 assembled to the frame 12 is rotatably moved from a predetermined position in the rotation direction (shown by a solid line in FIG. 5) to a position shown by the imaginary line in FIG. 5 with a predetermined amount against the urging force of the coil spring 13, and also axially moved from a predetermined position in the axial direction (shown by the solid line and the imaginary line in FIG. 5) to a position shown by a thin line in FIG. 5 with a predetermined amount against the urging force, of the coil spring 13 for engaging the engaging hook 14c of the handle lever 14 with the engaging portion 12e of the frame 12 in the rotation direction and the axial direction as shown in FIG. 4, the handle lever 14 can be maintained in the tentative holding position relative to the frame 12.

Accordingly, if the tentative holding position of the handle lever 14 is set in a specified position beforehand in which an access path of the inserting projection 15b is cleared for installing the outer handle 15 in the frame, and the engagement between the engaging hook 14c of the handle lever 14 and the engaging portion 12e of the frame 12 can be released in response to the outer handle 15 being moved with the full-stroke after the outer handle 15 is assembled to the frame 12 as shown by the imaginary line in FIG. 3 for engaging the inserting projection 15b of the outer handle 15 with the input portion 14b of the handle lever 14, the outer handle 15 can be installed in the frame 12 without interfering the handle lever 14 which is assembled to the frame 12 beforehand. Thus, an easy assembling can be available by inserting the outer handle 15 into the frame 12 and the assembly condition can be improved. The above-mentioned specified position is set at approximately 1-2 mm before the position in which the outer handle 15 is being moved with the full-stroke. In this specified position, the inserting projection 15b of the outer handle 15 is engaged and in contact with the input portion 14b of the handle lever 14 for rotating the handle lever 14 against the rotative urging force of the coil spring 13.

The vehicle door handle assembly of this embodiment can be feasible by providing the handle lever 14 which is rotatable and movable in the axial direction relative to the frame 12, the engaging hook 14d at the handle lever, the engaging portion 12e at the frame 12, and the axial urging spring between the handle lever 14 and the frame 12 for urging the handle lever 14 in the axial direction. Thus, the existing structure (frame 12 and handle lever 14) can be effectively used and the cost can be lower.

Especially in this embodiment of the present invention, the engaging hook 14c is integrally formed with the handle lever 14 and the engaging portion 12e is integrally formed with the frame 12. In addition, the rotative urging spring and the axial urging spring are configured by the single coil spring 13. Thus, the existing structure (frame 12, coil spring 13 and handle lever 14) can be effectively used and number of parts cannot be increased.

According to this embodiment of the present invention, the engaging hook 14c is integrally formed with the handle lever 14 and the engaging portion 12e is integrally formed with the frame 12. However, the engaging hook 14c and the engaging portion 12e can be separately formed with the handle lever 14 and the frame 12 respectively. In addition, the rotative urging spring and the axial urging spring are configured by the single coil spring 13. However, separate coil springs can be used.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

What is claimed is:

1. A vehicle door handle assembly comprising:
a frame secured to an inside of an outer panel for a vehicle door;
a handle lever rotatably assembled to the frame by a shaft portion and rotatably urged to a predetermined position in a rotation direction by a rotative urging spring;
a grip type outer handle installed from an outside of the outer panel and rotatably operating the handle lever;
the grip type outer handle including an engaging portion at one end inserted through an opening for insertion provided at the outer panel and engaged with a supporting portion in an inclinable manner provided at the frame, and an inserting projection having an engaging concave portion at the other end being inserted through each opening for insertion provided at the outer panel and the frame and being engaged with an input portion of the handle lever; whereby the handle lever is movable in an axial direction of the shaft portion relative to the frame;
an engaging hook formed at the handle lever;
an engaging portion formed at the frame for being engaged and disengaged with the engaging hook; and
an axial urging spring provided between the handle lever and the frame for urging the handle lever to a predetermined position in the axial direction in which the engaging hook is disengaged from the engaging portion in the axial direction;
wherein when the handle lever is rotatably moved from the predetermined position in the rotation direction with a predetermined amount against a urging force of the rotative urging spring and also axially moved from the predetermined position in the axial direction with a predetermined amount against a urging force of the axial urging spring, the engaging hook of the handle lever is engaged with the engaging portion of the frame in the rotation direction and the axial direction for holding the handle lever in a tentative holding position.

2. A vehicle door handle assembly according to claim 1, wherein: the rotative urging spring and the axial urging spring are configured by a single coil spring.

3. A vehicle door handle assembly according to claim 1, wherein: the engaging hook is integrally formed with the handle lever, and the engaging portion is integrally formed with the frame.

4. A vehicle door handle assembly according to claim 2, wherein: the engaging hook is integrally formed with the handle lever, and the engaging portion is integrally formed with the frame.

5. A vehicle door handle assembly according to claim 2, wherein:
the coil spring is engaged with the handle levee at one end and engaged with the frame at the other end when provided at a set position between the handle lever and the frame.

6. Method for attaching an outer door handle of a door handle assembly to a door frame, comprising the steps of:
rotating a handle lever assembled to the door frame from a predetermined position in a rotation direction to a position with a predetermined amount against a urging force of a coil spring;
moving the handle lever in an axial direction from a predetermined position in the axial direction to a position with a predetermined amount against the urging force of the coil spring;
engaging an engaging hook of the handle lever with an engaging portion of the frame in the rotation direction and the axial direction;
maintaining the handle lever in a tentative holding position relative to the frame; and
setting the tentative holding position in a specified position beforehand in which an access path of an inserting projection provided at the outer handle is cleared for installing the outer handle in the frame and engagement between the engaging hook of the handle lever and the engaging portion of the frame can be released in response to the outer handle being moved with a full-stroke after the outer handle is assembled to the frame.
